(19) United States
(12) Patent Application Publication
(10) Pub. No.: US 2007/0085349 A1
(43) Pub. Date: Apr. 19, 2007

(54) INERTIA-ACTUATED LOCKING DEVICE

(75) Inventors: Marcus Merideth, Westland, MI (US); Jim Loschiavo, Livonia, MI (US); Venky Krishnan, Canton, MI (US); Mahmoud Yousef Ghannam, Windsor (CA)

Correspondence Address: ARTZ & ARTZ, P.C., 28333 TELEGRAPH ROAD, SUITE 250, SOUTHFIELD, MI, 48034, US

(73) Assignee: FORD MOTOR COMPANY, Dearborn, MI (US)

(21) Appl. No.: 11/163,306

(22) Filed: Oct. 13, 2005

(51) Int. Cl. E05C 1/02

(52) U.S. Cl. 292/183

(57) ABSTRACT

An inertia-actuated locking device (“locking device”) for an improved latch assembly for a vehicle door. The locking device includes a housing, a plunger, and a detent lever. The plunger is slidably attached to the housing and movable to a locked position for locking the latch assembly. The detent lever is movable within the housing to a blocking position for holding the plunger in the locked position under the occurrence of a predetermined condition.

The present invention relates generally to latch assemblies, and more particularly to an inertia-actuated locking device for locking a latch assembly under a predetermined condition.

### BACKGROUND

Inertia-actuated locking devices (“locking devices”) for latch assemblies of vehicle doors have significantly advanced the safety of transportation. These locking devices typically lock vehicle doors under an inertial force during a side impact.

Existing locking devices can include a somewhat high number of components installed within a generally large area of the vehicle. For instance, one known locking device includes a power source, an electromagnet coil, a crash sensor, a container with an electrorheological medium (“ER fluid”) therein, and a driving member movable within the ER fluid. This driving member is operatively coupled between two or more movable release mechanisms of a door latch assembly. When the sensor detects a crash, the sensor actuates the electromagnet coil to produce an electric field that sufficiently increases the viscosity of the ER fluid to lock the driving member in position. In this way, the latch assembly cannot unlatch the door from its closed position. This locking device with its high number of components can have a somewhat lengthy installation time and thus increase the vehicle production costs.

Other locking devices can include components that are attached directly to the movable release mechanisms of the door latch assembly. For instance, one known locking device includes a blocking lever pivotally attached directly to an outside release lever (“OS release lever). In this respect, the OS release lever carries the mass of the blocking lever. This construction can increase the amount of force that a user must apply for moving the release lever and opening the door. It will also be appreciated that these blocking levers have multiple degrees of movement that can decrease the amount of otherwise available space in the latch assembly.

In addition, other known locking devices can be comprised of components that are also integral parts of the latch assemblies. In other words, these latch assemblies cannot satisfy their intended purposes of opening and closing the door without the components of the locking device. To that end, these locking devices may not simply be added or otherwise installed in conventional latch assemblies without substantial modifications therein.

It would therefore be desirable to provide an inertia-actuated locking device that has an efficiently packaged construction that can be easily installed in a conventional latch assembly.

### SUMMARY OF THE INVENTION

An inertia-actuated locking device (“locking device”) for a latch assembly of a vehicle door is provided. The locking device includes a housing, a plunger, and a detent lever. The plunger is slidably attached to the housing and movable to a locked position for locking the latch assembly. The detent lever is movable within the housing to a blocking position for holding the plunger in the locked position under the occurrence of a predetermined condition.

One advantage of the invention is that an inertia-actuated locking device is provided that locks a latch assembly for a vehicle door under an inertial force, such as one during a side impact.

Another advantage of the invention is that an inertia-actuated locking device is provided that has a robust construction that is freely movable to a locked configuration after a rather lengthy period of nonuse in moist and/or dust-filled environments.

Yet another advantage of the invention is that an inertia-actuated locking device is provided that has an efficiently packaged construction for use in small space applications.

Still another advantage of the invention is that an inertia-actuated locking device is provided that can be easily installed in conventional latch assemblies without significant modifications therein and thus decreases the vehicle production costs.

Other advantages of the present invention will become apparent upon considering the following detailed description and appended claims, and upon reference to the accompanying drawings.

### BRIEF DESCRIPTION OF THE DRAWINGS

For a more complete understanding of this invention, reference should now be made to the embodiments illustrated in greater detail in the accompanying drawings and described below by way of the examples of the invention:

FIG. 1 is a perspective view of an improved latch assembly with an inertia-actuated locking device, according to one advantageous embodiment of the claimed invention.

FIG. 2 is a cross-sectional view of the locking device shown in FIG. 1, as taken along line 2-2, illustrating the locking device in a first unlocked position.

FIG. 3 is a cross-sectional view of the locking device shown in FIG. 1, as taken along line 2-2, illustrating the locking device in a second unlocked position.

FIG. 4 is a cross-sectional view of the locking device shown in FIG. 1, as taken along line 2-2, illustrating the locking device in a locked position.

FIG. 5A is a side plan view of the detent lever for the locking device shown in FIGS. 2 through 4.

FIG. 5B is a bottom plan view of the locking lever for the locking device shown in FIG. 5A.

FIG. 5C is a front plan view of the locking lever for the locking device shown in FIG. 5A.

FIG. 6 is a cross-sectional view of the locking device in FIG. 1, according to an alternate embodiment of the invention.

FIG. 7 is a cross-sectional view of the locking device shown in FIG. 1, according to yet another alternate embodiment of the invention.

FIG. 8 is a cross-sectional view of the locking device shown in FIG. 1, according to still another alternate embodiment of the invention.

FIG. 9 is a perspective view of the locking device shown in FIG. 1 illustrating the locking device having a sealed housing.

FIG. 10 is an exploded view of the locking device shown in FIG. 9.

FIG. 11 is an inner plan view of the first housing portion for the locking device shown in FIG. 10.

FIG. 12 is an inner plan view of the second housing portion for the locking device shown in FIG. 10.

FIG. 13 is a cross-sectional view of the first housing portion shown in FIG. 11, as taken along line 11-11.

FIG. 14 is a cross-sectional view of the second housing portion shown in FIG. 12, as taken along line 14-14.

FIG. 15 is a bottom perspective view of the locking device shown in FIG. 9.

### DETAILED DESCRIPTION OF THE INVENTION

In the following figures, the same reference numerals are used to identify the same components in the various views.

The present invention is particularly suited for an inertia-actuated locking device installed in a latch assembly for a vehicle door. However, various other embodiments are contemplated having different combinations of the described features, having additional features other than those described herein, or even lacking one or more of those features. For instance, it is contemplated that the inertia-actuated locking device can be installed in other suitable latch assemblies as desired.

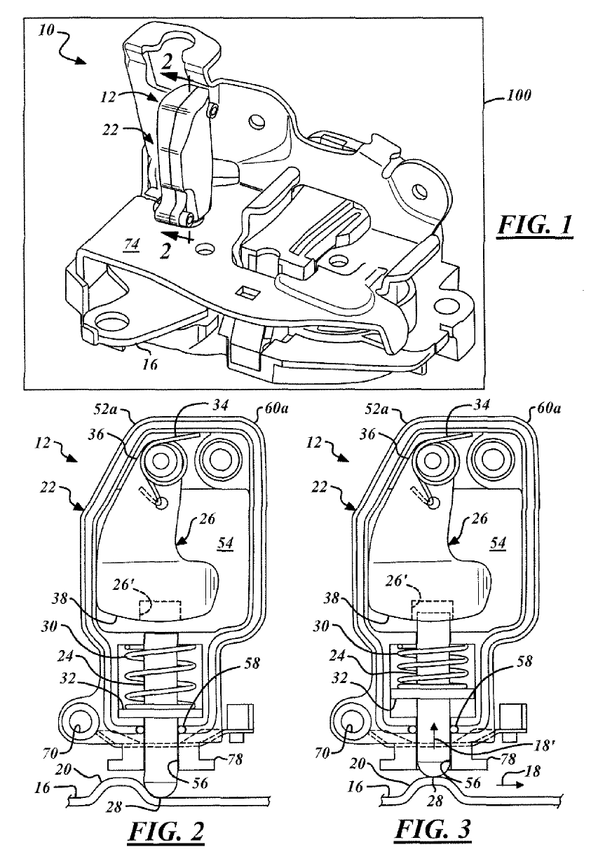

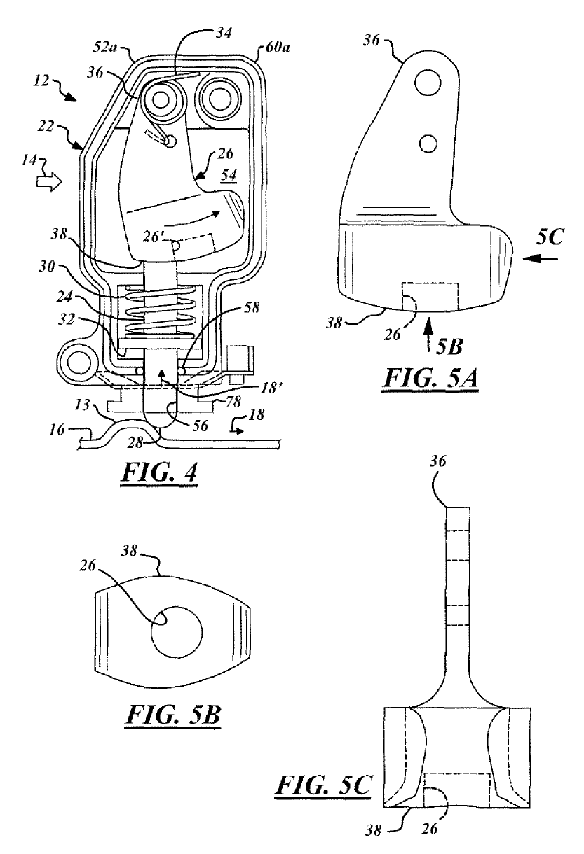

Referring to FIG. 1, there is shown an improved latch assembly 10 with an inertia-actuated locking device 12 (“locking device”) for a vehicle door, according to one advantageous embodiment of the claimed invention. This locking device 12 is utilized for locking the latch assembly 10 in a latched position under a predetermined inertial force 14 (shown in FIG. 4). In this way, the locking device 12 locks the vehicle door 100 closed during a side impact or other collision.

The latch assembly 10 includes an outside release lever 16 (“OS release lever”) for selectively unlatching the vehicle door 100 from its closed position. Specifically, the OS release lever 16 is operatively coupled between a conventional actuation mechanism (not shown) and a conventional door fastener (not shown). Also, the OS release lever 16 is movable along a predetermined direction between a latched position (shown in FIG. 2) and an unlatched position (shown in FIG. 3).

By way of example, the OS release lever 16 can be operatively coupled between an outside door handle and a striker. In this way, actuation of the door handle moves the OS release lever 16 along the direction 18 (shown in FIG. 3) to the unlatched position for releasing the striker from a pin (not shown) and opening the vehicle door 100. As detailed below, the OS release lever 16 has a protrusion 20 formed thereon for contacting the locking device 12 and locking the OS release lever 16 in its latched position. It will be appreciated that the latch assembly 10 can have a variety of other release mechanisms that are selectively locked by the locking device 12.

The locking device 12 is movable to two unlocked positions and one locked position as respectively shown in FIGS. 2 through 4. To this end, the locking device 12 is generally comprised of a housing 22, a plunger 24, and a detent lever 26 with the plunger 24 and the detent lever 26 movable to respective positions for locking the OS release lever 16 in its latched position.

In particular, the plunger 24 is slidably attached to the housing 22 and movable between a locked position (shown in FIGS. 2 and 4) and an unlocked position (shown in FIG. 3). The plunger 24 further includes an abutment portion 28 directly contacting the protrusion 20 on the OS release lever 16 and selectively preventing the OS release lever 16 from moving to its unlatched position. Specifically, in the locked position, the plunger 24 sufficiently extends from the housing 22 for blocking the OS release lever 16 in the direction 18. In the unlocked position, the plunger 24 is sufficiently retracted within the housing 22 for providing sufficient clearance for the protrusion 20 to move the OS release lever 16 in the direction 18.

The plunger 24 and the housing 22 have a compression spring 30 directly therebetween for moving the plunger 24 to the locked position. Also, the plunger 24 has an annular flange 32 for contacting the housing 22 and securing the plunger 24 therein. However, other suitable biasing members can be utilized as desired. Also, it is understood that the biasing member can be directly or indirectly coupled between the plunger 24 or other suitable fixture.

Furthermore, the abutment portion 28, of the plunger 24 and the protrusion 20 of the OS release lever 16 respectively have sufficient constructions for moving the plunger 24 from the locked position to the unlocked position during normal operation of the latch assembly 10. Specifically, in this embodiment, normal operation of the latch assembly 10 is comprised of moving the OS release lever 16 while substantially little or no inertial force 14 is imparted on the locking device 12.

Also, in this embodiment as best shown in FIG. 3, the protrusion 20 and the abutment portion 28 have sufficiently rounded features for forcing the protrusion 20 against the abutment portion 28 in one direction 18 so as to move the plunger 24 in another direction 18′ essentially perpendicular thereto. It is understood that the locking device 12 can include various other suitable means for moving the plunger 24 between the locked position and the unlocked position.

The detent lever 26 is movable within the housing 22 between a rest position (shown in FIGS. 2 and 3) and a blocking position (shown in FIG. 4). Specifically, in the rest position, the detent lever 26 has a recess 26′ that provides sufficient clearance for moving the plunger 24 to its unlocked position (as best shown in FIG. 3). In the blocking position, the detent lever 26 is positioned for directly contacting and blocking the plunger 24 from moving to its unlocked position. Accordingly, in the blocking position, the detent lever 26 holds the plunger 24 in the locked position and prevents the OS release lever 16 from moving to the unlatched position. In other words, the detent lever 26 in its blocking position secures the vehicle door 100 in its closed position.

The detent lever 26 and the housing 22 have a torsion spring 34 directly therebetween for moving the detent lever 26 to the rest position. However, other suitable resilient members can be utilized as desired. In addition, it is contemplated that the resilient member can be directly or indirectly coupled between the detent lever 26 and any suitable fixture.

Referring to FIG. 4, the detent lever 26 is moved to its blocking position by an inertial force 14, such as one typically associated with a vehicle side impact. With specific attention to FIGS. 5A through 5C, the detent lever 26 includes an attachment end portion 36 and an opposing pivoting end portion 38. The attachment end portion 36 is pivotally attached directly to the housing 22. The pivoting end portion 38 has a substantially larger mass than the attachment end portion 36 for quickly moving the detent lever 26 to the blocking position under the inertial force 14 and minimizing the overall weight of the locking device 12.

Furthermore, the detent lever 26 has a sufficiently smaller mass than the OS release lever 16 for responding to the inertial force 14 faster than the OS release lever 16.

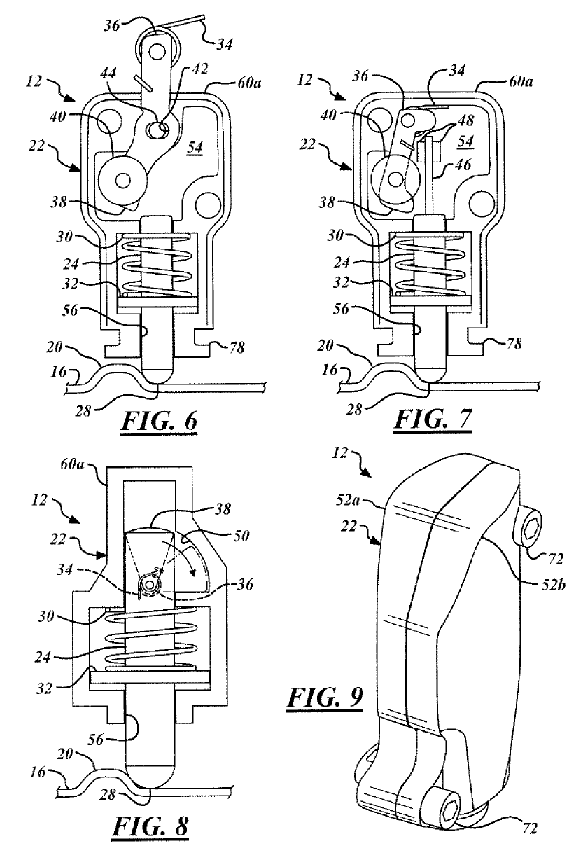

In this embodiment, the detent lever 26 is a one-piece die-cast metal construction. However, it will be appreciated that the detent lever 26 can instead be comprised of other suitable materials and constructions. For instance, as shown in FIGS. 6 and 7, the detent lever 26 can have a thin plate construction across its entire length with a separate counterweight mass 40 attached to the pivoting end portion 38.

It is understood that the detent lever 26 can be pivotally attached directly or indirectly to the housing 22 or other suitable fixtures as desired. For example, FIGS. 6 through 8 shows the locking device 12 in FIG. 2 with respect to alternative embodiments of the invention.

Referring to FIG. 6, the detent lever 26 can be pivotally attached to a latch assembly fixture or a vehicle door fixture external to the housing 22. Also, in this embodiment, the detent lever 26 has a slot 42 for receiving a guide member 44 extending from the housing 22. This feature can prevent the detent lever 26 from moving beyond its blocking position or otherwise assist in preventing the lever 26 from bouncing between its rest position and blocking position.

Referring now to the alternative embodiment shown in FIG. 7, the detent lever 26 is movable by the plunger 24 during normal operation of the latch assembly 10 to prevent the detent lever 26 from becoming fixed in one position. Specifically, the plunger 24 has a pole member 46 extending therefrom for directly contacting and pivoting the detent lever 26 as the plunger 24 is moved to its unlocked position. In this embodiment, the pole member 46 slides between a pair of guide tabs 48 extending from the housing 22. In this way, the pole member 46 pivots the detent lever 26 by a sufficiently small angle for breaking any sediment or corrosion between the lever 26 and the housing 22 while providing the plunger 24 with sufficient clearance to move to its unlocked position.

With attention to the alternative embodiment shown in FIG. 8, the detent lever 26 is pivotally attached directly to the plunger 24. During normal operation of the latch assembly 10, the torsion spring 34 sufficiently aligns the detent lever 26 with the plunger 24 and the housing 22 for moving the plunger 24 between its locked position and unlocked position. Under the inertial force 14, e.g. a side impact, the detent lever 26 pivots into a notch 50 formed in the housing 22 and become lodged therein so as to prevent the plunger 24 from being forced further upward to its unlocked position.

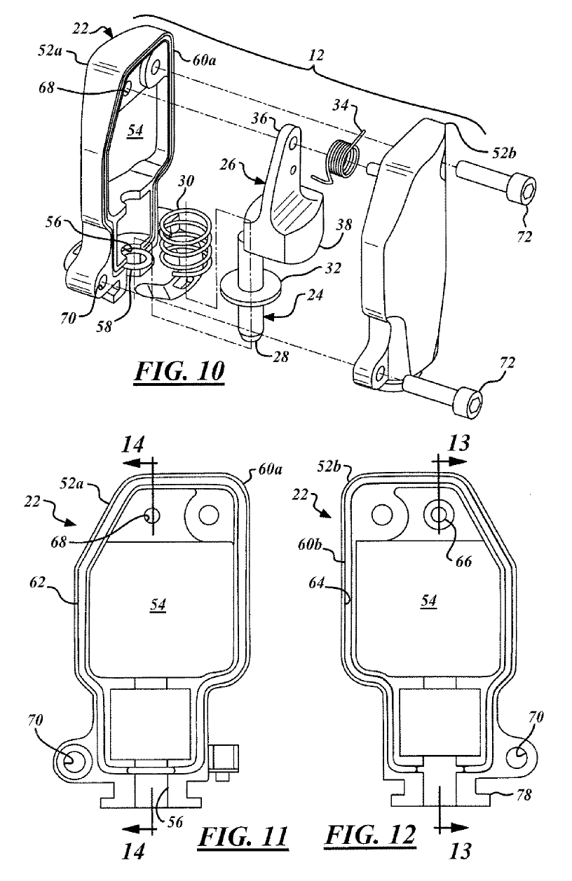

Referring now to FIGS. 9 and 10, the detent lever 26, the compression spring 30, and the torsion spring 34 are sealingly contained within the housing 22. This feature is beneficial for preventing those moving components 26, 30, 34 from being exposed to moisture, which could otherwise cause those components 26, 30, 34 to corrode and thus become fixed in one position. This feature also prevents those moving components 26, 30, 34 from being exposed to dust that can otherwise accumulate on the components 26, 30, 34 over a long period of nonuse and accordingly impede free movement.

As shown in FIG. 10, the housing 22 is comprised of two mating portions 52a, 52b that define a cavity 54 and an aperture 56. The cavity 54 has the detent lever 26, the compression spring 30, and the torsion spring 34 sealed therein. The aperture 56 has the plunger 24 slidable therethrough with a seal 58 sandwiched between the plunger 24 and the housing 22.

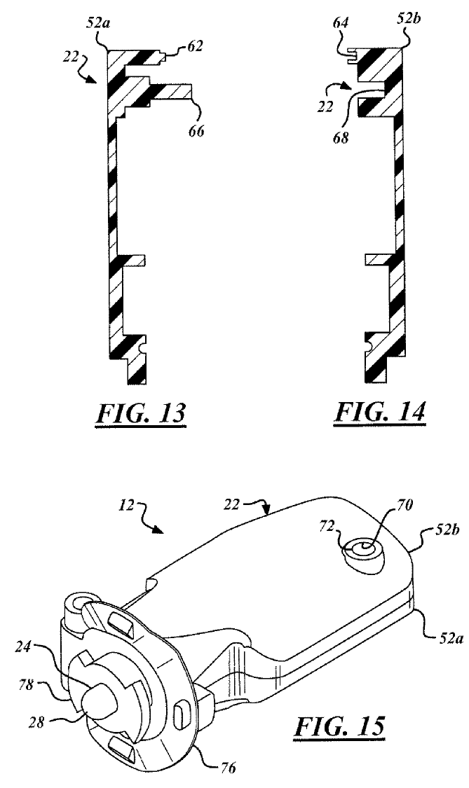

In addition, as shown in FIGS. 11 through 14, the two mating portions 52a, 52b of the housing 22 have respective peripheral edges 60a, 60b that are sealingly attached together. Namely, the peripheral edge 60a of the first mating portion 52a has a ridge 62 extending therefrom while the peripheral edge 60b of the second mating portion 52b has a groove 64 therein for receiving the ridge 62 of the first mating portion 52a. This feature is beneficial for preventing moisture and dust from entering the housing 22. Also, this feature is beneficial for providing self-locating structures and facilitating the manufacture of the locking device 12.

Also, in this embodiment, the first mating portion 52a has a locating member 66 extending therefrom and the second mating portion 52b has a locating recess 68 therein for receiving the locating member 66.

The mating portions 52a, 52b further include one or more through-holes 70 with one or more bolt fasteners 72 therein for attaching the mating portions 52a, 52b together. However, it is contemplated other suitable fastening means can be utilized as desired. It will also be appreciated that the housing 22 can instead be comprised of more or less than two components and have various other suitable constructions as desired.

Referring back to FIG. 1, the locking device 12 is attached to a stationary cover plate 74 for the latch assembly 10. In other words, the locking device 12 is fixed in one position and therefore is not mounted to a movable component, e.g. a release mechanism. For this reason, the locking device 12 does not require additional force for moving the weight of the locking device 12 when operating the latch assembly 10. Also, the locking device 12 does not require a substantial amount of space in the latch assembly 10 that would otherwise be necessary for its path of movement.

Also in this embodiment, the locking device 12 has a substantially compact construction. For this additional reason, the locking device 12 does not require a substantial amount in the latch assembly 10. Also, the locking device 12 can be easily installed in a variety of conventional latch assemblies with few modifications therein.

Referring to FIG. 15, the housing 22 further includes a locking plate 76 attached to a bottom side (not shown) of the stationary cover plate 74 for stabilizing the locking device 12 thereon. Also, in this embodiment, the housing 22 further defines a cam structure 78 for inserting into a likewise shaped hole in the cover plate 74. This cam structure 78 positions the locking device 12 on the cover plate 74 in a predetermined location and further stabilizes the locking device 12 on the cover plate 74.

It is understood that the locking device 12 can instead be attached to other suitable stationary or movable portions of the latch assembly 10, a vehicle door fixture, other suitable fixtures, or any combination thereof.

While particular embodiments of the invention have been shown and described, it will be understood, of course, that the invention is not limited thereto since modifications may be made by those skilled in the art, particularly in light of the foregoing teachings. Accordingly, it is intended that the invention be limited only in terms of the appended claims.

What is claimed is:

1. An inertia-actuated locking device for an improved latch assembly for a vehicle door, comprising:
a housing;
a plunger slidably attached to said housing;
said plunger movable to a locked position for locking said improved latch assembly; and a detent lever within said housing;
said detent lever movable to a blocking position for holding said plunger in said locked position under occurrence of a predetermined condition.

2. The inertia-actuated locking device recited in claim 1 wherein said plunger in said locked position blocks a release mechanism of said improved latch assembly.

3. The inertia-actuated locking device recited in claim 1 wherein said plunger is moved to said locked position by a biasing member.

4. The inertia-actuated locking device recited in claim 3 wherein said biasing member is sealingly contained within said housing for preventing exposure to moisture and dust thereby preventing said plunger from becoming fixed in one position.

5. The inertia-actuated locking device recited in claim 1 wherein said plunger is further movable to an unlocked position for unlocking said improved latch assembly.

6. The inertia-actuated locking device recited in claim 5 wherein said plunger is moved to said unlocked position by a release mechanism of said improved latch assembly.

7. The inertia-actuated locking device recited in claim 1 wherein said detent lever moves to said blocking position by an inertial force.

8. The inertia-actuated locking device recited in claim 7 wherein said detent lever has an attachment end portion and an opposing pivoting end portion with a substantially larger mass than said attachment end portion.

9. The inertia-actuated locking device recited in claim 1 wherein said detent lever is further movable to a rest position whereby said plunger is further movable to an unlocked position.

10. The inertia-actuated locking device recited in claim 9 wherein said detent lever is moved to said rest position by a resilient member.

11. The inertia-actuated locking device recited in claim 1 wherein said housing, said plunger, and said detent lever comprise an add-on locking device for use in a conventional latch assembly.

12. The inertia-actuated locking device recited in claim 1 wherein said detent lever is further movable by said plunger during normal operation of said improved latch assembly for preventing said detent lever from becoming fixed in one position.

13. The inertia-actuated locking device recited in claim 1 wherein said detent lever is sealingly contained within said housing for preventing exposure to moisture and dust thereby preventing said detent lever from becoming fixed in one position.

14. The inertia-actuated locking device recited in claim 1 wherein said housing defines an aperture with said plunger slidable therethrough and a seal sandwiched between said plunger and said housing.

15. An inertia-actuated locking device for an improved latch assembly for a vehicle door, comprising:
a housing fixed in one position within said vehicle door;
a plunger slidably attached to said housing;
said plunger movable to a locked position for locking said improved latch assembly; and
a detent lever within said housing;
said detent lever movable to a blocking position for holding said plunger in said locked position under occurrence of a predetermined condition.

16. The improved latch assembly recited in claim 15 wherein said housing is attached directly to one of a vehicle door fixture and a stationary cover plate for said improved latch assembly.

17. The improved latch assembly recited in claim 15 wherein said housing has a substantially compact construction with said detent lever sealed therein and said improved latch assembly external thereto.

18. The improved latch assembly recited in claim 15 wherein said housing is comprised of at least two mating portions with at least one of a self-locating fastener and a fastening structure therein.

19. An improved latch assembly for a vehicle door, comprising:
a release mechanism movable between an unlatched position and a latched position;
an inertia-actuated locking device for locking said release mechanism in said latched position under a predetermined condition;
said inertia-actuated locking device comprised of a housing, a plunger, and a detent lever;
said housing attached directly to a stationary fixture;
said plunger slidably attached to said housing;
said plunger movable to a locked position for locking said improved latch assembly; and
said detent lever within said housing;
said detent lever movable to a blocking position for holding said plunger in said locked position under occurrence of said predetermined condition.

20. The improved latch assembly recited in claim 19 further comprising:
a biasing member moving said plunger to said locked position; and
a resilient member moving said detent lever to a rest position whereby said plunger is movable to an unlocked position;
said plunger moved to said unlocked position by a protrusion on said release mechanism;
said plunger in said locked position directly blocking said release mechanism from moving to said unlatched position;
said detent lever moving to said blocking position under an inertial force;
said detent lever having an attachment end portion and an opposing pivoting end portion with a substantially larger mass than said attachment end portion;
said detent lever pivotally attached directly to one of said housing and said plunger;
said detent lever having a sufficiently smaller mass than said release mechanism for responding to said inertial force more quickly than said release mechanism;
said detent lever, said resilient member, and said biasing member sealingly contained within said housing;
said housing defining an aperture with said plunger slidable therethrough and a seal sandwiched between said plunger and said housing;
said housing having a substantially compact construction with said release mechanism external thereto;
said housing comprised of at least two mating portions with at least one of a self-locating fastener and a fastening structure therein;
said stationary fixture being at least one of a cover plate for said improved latch assembly and a vehicle door fixture.
